(19) United States
(12) Patent Application Publication
(10) Pub. No.: US 2003/0036033 A1
(43) Pub. Date: Feb. 20, 2003

(54) Water delivery and filtration system

(76) Inventor: James W. Chandler, Ashland, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/216,462

(22) Filed: Aug. 9, 2002

Related U.S. Application Data
(60) Provisional application No. 60/311,230, filed on Aug. 9, 2001.

(51) Int. Cl. A61G 15/00

(52) U.S. Cl. 433/77; 210/764

(57) ABSTRACT

Systems and methods for controlling the presence and growth of microorganisms and biofilms in water lines is provided. The systems include, for example, a valved, multi-port control manifold for accepting inlet water to be treated and a filter for (1) reducing particulate physical matter, (2) further reducing particulate matter while also reducing the content of absorbable organics, and (3) physically removing microorganisms.

### CROSS-REFERENCES

This application claims the benefit of U.S. Provisional Application Serial No. 60/311,230 filed Aug. 9, 2001. This application is also a continuation-in-part of U.S. Patent Application Serial No. ______, filed Jul. 22, 2002, which is a continuation of U.S. Pat. No. 6,423,219, filed Sep. 14, 2000, which claims priority from provisional patent application Serial No. 60/153,871 and filed Sep. 14, 1999.

### FIELD OF THE INVENTION

The invention relates to the filtration of water, air, and other fluids. It finds particular application to a method and system for controlling the growth of microorganisms and the development of biofilms within water delivery systems.

### BACKGROUND OF THE INVENTION

Organisms enter the water system by various means including the main water supply, from a patient or from dead plumbing legs within the system. Municipal water usually contains chlorine or chloramine residuals present for the purpose of controlling coliform bacteria and other pathogenic organisms. These chemical residuals are not, however, totally effective at controlling the growth of secondary pathogens, also known as heterotrophic, mesophillic, opportunistic pathogens.

Most dental delivery equipment uses a combination of water and compressed air through a network of tiny diameter tubing, control blocks, kink valves, pinch valves, and solenoid valves. The throughput of a typical dental operatory system may only average one liter per day, consequently, water in the lines rises in temperature and becomes almost stagnated. Another problem related directly to the water lines is the fact that they encourage laminar water flow instead of radial flow. In a laminar flow situation, water flows mostly through the center-most portion of the tubing creating virtually no flow or turbulence at the surface of the conduit. Further, surface-to-volume ratios increase. All of these factors tend to negate the controls employed by most municipal water systems.

Another negative factor found in most dental equipment is known as dead end plumbing “legs.” In this regard, water flows to each dental handpiece, air/water syringe and scaler through a narrow tube terminating at the appliance. Some of these appliances may not require water flow routinely throughout the day and may actually go for days or weeks without discharging water. This creates a quiescent, warming environment for microorganisms to experience growth. Often times, the result of these dead end legs is the development of thick biofilms and the discharge of water with huge colony counts of planktonic organisms when the appliance finally is used.

Planktonic organisms and microbial biofilms present a potential health concern for the public, especially in medical and dental settings where patients may be compromised by lowered immune function due to illness and/or treatments. Swallowing water or inhaling aerosols that contains high levels of microorganisms are the most obvious way potential pathogens enter the body. Additionally, procedures such as incisions, drilling of teeth and bone, scraping gums, etc. involve or require the opening of “windows” to the body. Microorganisms from water of poor microbiolical quality can then enter the body through these “windows” creating undesirable or potentially deadly consequences.

Another area of concern for the field of dentistry is the lack of quality compressed air being used in many dental practices. Like water, the air quality must be high since patients and staff are all exposed during procedures. Although air generally has different species of organisms than does water, their presence can be potentially pathogenic and should be addressed. Due to the wide variety and quality of compressors in use, other problems such as the presence of hydrocarbons from oil-type systems as well as condensate in air lines can plague dental systems.

### SUMMARY OF THE INVENTION

In one embodiment, an apparatus for use in a dental system is provided. The apparatus has, for example, at least one holder for holding a dental appliance when the dental appliance is not in use, at least one input port, and at least one output port in fluid communication with the input port. The input port has, for example, a connector for releasably connecting the input port to a mating connector that provides a source of fluid to the dental appliance. Fluid communication as used herein means the connection of one or more components either directly of indirectly through intermediary components such that fluid can pass from, to or between the connected components.

In another embodiment, a fluid delivery system for a dental operatory is provided. The system has, for example, a source of fluid, a recirculation manifold, and a pump in fluid communication with the recirculation manifold and the fluid source. The recirculation manifold has, for example, at least one holder for holding a dental appliance when the dental appliance is not in use, at least one input port, and at least one output port in fluid communication with the input port. The input port includes, for example, a connector for releasably connecting the input port to a mating connector that provides a source of fluid to the dental appliance.

### BRIEF DESCRIPTION OF THE DRAWINGS

FIG. 1 is an exemplary overall system diagram of one embodiment of a fluid delivery system in accordance with the present invention.

FIG. 2 is a perspective view of one embodiment of a fluid deliver system having a switchable water/air source control with three or more positions.

FIG. 3 is an exemplary overall system diagram of a second embodiment of a fluid delivery system in accordance with the present invention.

FIG. 4 is an exemplary cross-sectional view of a retrofit adapter embodiment in accordance with the present invention.

FIG. 5 is an exemplary overall system diagram of a third embodiment of a fluid delivery system in accordance with the present invention.

FIGS. 6 and 7A are exemplary perspective views of one embodiment of a recirculation manifold in accordance with the present invention. FIGS. 7B and 7C are exemplary views of one embodiment of a quick couple port and coupling of the present invention.

FIGS. 8 and 9 illustrate exemplary fourth and fifth embodiments of a fluid deliver system in accordance with the present invention.

FIG. 10 illustrates an exemplary cross-section of one embodiment of a control manifold/mixing chamber combination in accordance with the present invention.

FIG. 11 illustrates an exemplary cross-section of one embodiment of a filter element in accordance with the present invention.

FIGS. 12 and 13 illustrate a sixth embodiment of a fluid delivery system in accordance with the present invention.

FIG. 14 illustrates an exemplary cross-section of one embodiment of mixing chamber in accordance with the present invention.

FIG. 15 illustrates an exemplary cross-section of one embodiment of an injection input port in accordance with the present invention.

### DETAILED DESCRIPTION OF ILLUSTRATED EMBODIMENT

As described in detail in U.S. Pat. No. 6,423,219 (hereinafter '219 patent), which is hereby fully incorporated by reference, organisms are present in two fundamental modes—sessile and planktonic. Organisms in a planktonic state are free-floating in a medium. They can be dispensed into drinking devices, medical appliances, etc. and are the organisms to which users and patients are directly exposed. Organisms in a sessile state are attached to interior surfaces of, for example, tanks, storage vessels, tubing, pipes and valves and are usually members of communities known as biofilms. Organisms found in biofilms are typically much more resistant to treatment methods than their planktonic counterparts of the same species.

Microbial biofilms develop when microorganisms irreversibly attach themselves to a surface and produce extracellular polymers that facilitate adhesion while also providing a structural matrix. A distinguishing characteristic of biofilms is the powerful extracellular, polymeric substances (primarily polysaccharides) surrounding and encasing the cells. These substances generally appear as thin strands connecting the cells to the surface and to one another or as sheets of amorphous material on a surface. Most of the biofilm is comprised of the polymeric substance rather than cells. The biofilm matrix acts as a sort of filter in that it traps minerals from a fluid stream as well as serum components produced by the host organisms.

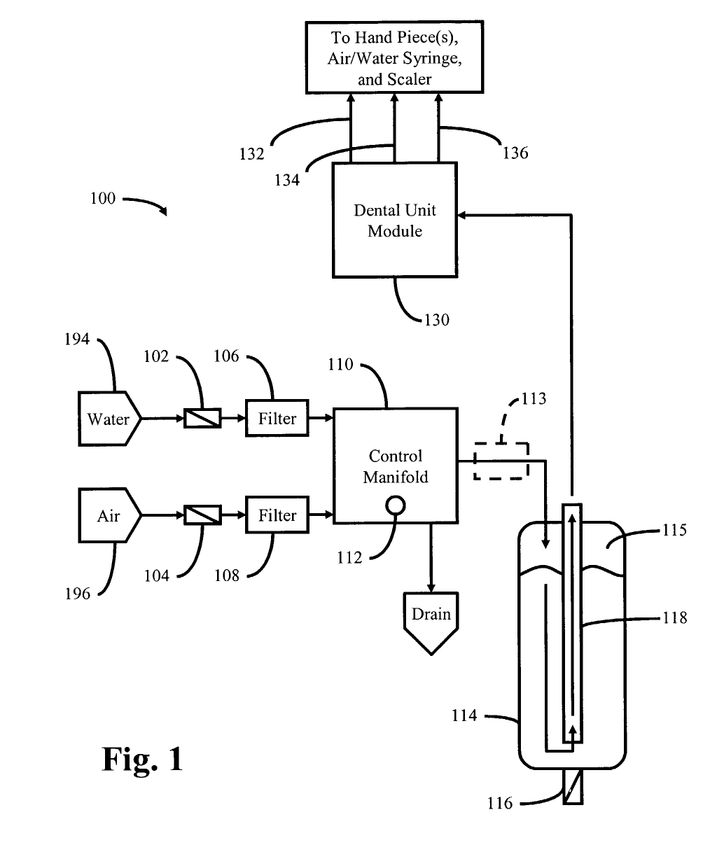

Referring now to FIG. 1, a block diagram of a first embodiment 100 of water delivery and filtration system is shown. This embodiment can be incorporated in a dental chair assembly, casework module, mobile, portable or full operatory dental delivery system that contains any and all normal components usually found in such equipment. In addition to the standard components, this first embodiment 100 can be further modified to have additional features to be discussed below that can be integrated into, for example, the base of a dental chair or operatory dental delivery system, the seat portion of the dental chair, the seat back of the dental chair, or discretely coupled to the dental chair or operatory delivery system itself. The system components of the present embodiment and invention can also be interspersed throughout the dental operatory itself. Unless otherwise indicated, the piping or hoses interconnecting components of the present invention are preferably conventional ⅜″ O.D.×¼″ I.D. or ¼″ O.D.×⅛″ I.D. tubing. Also, unless otherwise noted, all valves are manual, electrical, or air actuated and of conventional ball-type or similar construction providing for full-on, full-off, and partial-on positions therebetween.

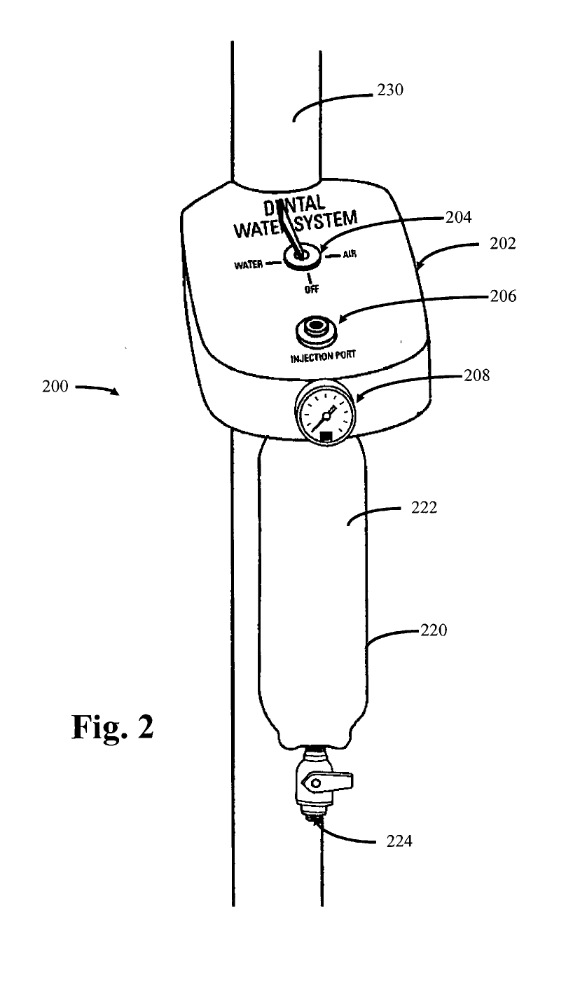

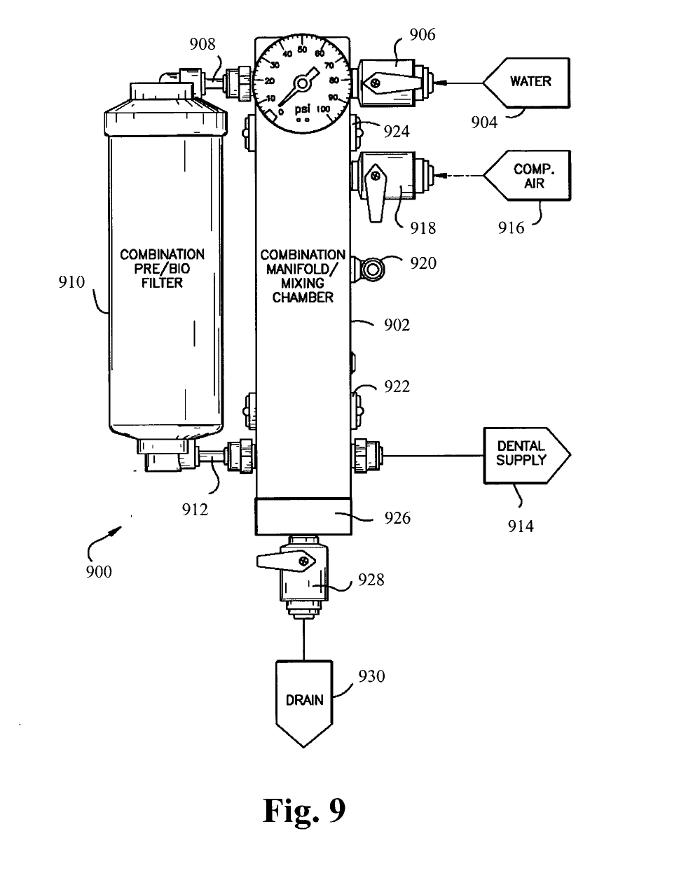

In a “service” mode of operation, water 194, air 196 and electrical power enter system 100 through a distribution/junction box (not shown). Valves controlling the water and air flow are controlled by a control manifold 110. Various embodiments of control manifold 110 are described with reference to the incorporated by reference '219 patent and herein FIGS. 2, 4, 8, 9, 10, 12 and 13. Water 194 flows through a check valve 102 and enters a multi-stage bio filter 106 where particulates, certain heavy metals, water treatment byproducts, bacteria, etc. are removed. Various embodiments of the multi-stage bio filter 106 are described in the incorporated by reference '219 patent and herein FIG. 11. Other forms of water treatment equipment may also be employed at filter 106 or after control manifold 110 including but not limited to ultraviolet, ozone gas, membrane filtration 113 and the like as necessary for water conditions.

Water 194 passes through control manifold 110 and is directed by valves, borings and tubing to a mixing chamber 114. Various embodiments of mixing chamber 114 are disclosed in the incorporated by reference '219 patent and herein FIGS. 2, 4, and 14. Water 194 enters the mixing chamber 114 from the top, passing through an air gap 115 portion, and exits through the bottom of a dip tube 118. Filtered water then leaves the mixing chamber 114 and is directed to the endpoint of a dental delivery system 130 where it is then provided to dental hand pieces 132 and 134 (high/low speed hand piece and air/water syringe) as well as a scaler 136 for use on patients as needed by a dental practitioner.

In one configuration, the filtered water delivered to dental delivery system 130 is under full line pressure created by water supply source 194. In this configuration, the mixing chamber 114 is a passive component. In another configuration, water in mixing chamber 114 can be delivered to dental delivery system 130 by turning off the water supply 194 and opening pressurized air source 196. In this configuration, air is delivered through a check valve 104 and air filter 108 to control manifold 110 where it then enters the mixing chamber 114 driving the water therein out of the chamber and into dental delivery system 130 for use as needed. This configuration is useful should the main water supply 194 be interrupted for any reason. Another use of this configuration is for the maintenance of dental delivery system 130 through the delivery of water line cleaners contained in the mixing chamber 114. Yet another use of this configuration is for the deliver of medicaments added to mixing chamber 114 through to dental delivery system 130.

In regards to the maintenance mode or configuration, dental waterline systems should occasionally be cleaned to help prevent the growth of biofilms. To enter the maintenance mode of the present embodiment, the system 100 must first be purged to remove all water therein. In this regard, the pressurized water source 194 is turned off and the air supply line 196 is turned on. To quickly remove existing water from the mixing chamber 114, a convenience drain 116 at the bottom of mixing chamber 114 can be opened. After a few seconds, the water within mixing chamber 114 is displaced by air. Alternatively, water within mixing chamber 114 can be displaced through dental appliances 132, 134, and 136.

Drain valve 116 is then closed and the dental appliances 132, 134 or 136 are discharged. It should be noted here that the purging of the mixing chamber 114 through valve 116 can be done manually or automatically based upon the system design. However, discharging of the dental appliances 132, 134 and 136 is preferably done manually due to current dental equipment designs.

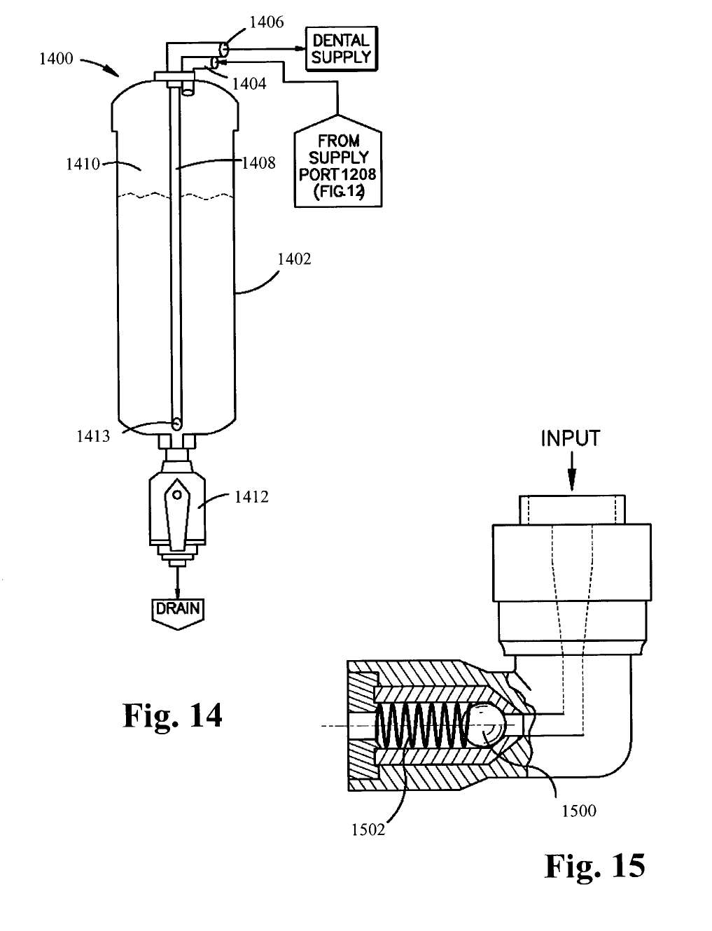

Before any cleaning solution concentrate can enter the system, it preferable that the air pressure within system 100 be relieved. This is accomplished by first closing the air supply valve 196 and opening any of the dental appliances 132, 134, 136 or the convenience drain 116 for a few seconds. Once the system is devoid of pressure, a line cleaner or concentrate can be injected into an port 112 preferably located at control manifold 110 or mixing chamber 114. Examples of port 112 are more fully described in the incorporated by reference '219 patent and herein in FIG. 15. This is done by using, for example, a common leur tip syringe or an optional automatic metering pump assembly having a feed pump. Injecting through port 112 rather than disassembling or removing system components protects the inner waterline components of the system from the potential of contamination from outside the system.

The injected cleaning solution remains in control manifold 110 or mixing chamber 114 until water supply 194 is opened. Once opened, water proceeds through filter 106, mixes with the concentrated cleaning solution in the control manifold 110 and blends it into the mixing chamber 114. Water continues until a sufficient volume has entered mixing chamber 114 compressing the entrained air forming air gap 115 at the top of mixing chamber 114.

At this point, the cleaning solution has been mixed to the proper dilution and can be delivered to the remainder of the system. So that the cleaning solution is not further diluted, water supply 194 is preferably turned off and air supply 196 turned on so that air may force the diluted cleaning solution in mixing chamber 114 to the endpoints of dental delivery system 130. Selectively, dental appliances 132, 134 and 136 are now opened until each is relieved of air and emits cleaning solution. Depending on the type of cleaning solution used, it should remain within the system for some length of time in order to kill microorganisms, destroy biofilms, etc. More information describing one embodiment of a cleaning solution is found in the incorporated by reference '219 patent.

The system must now be purged of the cleaning solution and rinsed. This is preferably accomplished by first briefly opening the convenience drain 116 to purge the mixing chamber 114 of excess cleaning solution. Once air emerges from the convenience drain 116, valve 116 is closed and dental appliances 132, 134 and 136 are opened selectively until all of the cleaning solution has been purged and air emerges. The air supply 196 is then preferably closed and the system pressure relieved as described earlier.

In order to rinse the waterlines and prepare them for use, water supply 194 is preferably opened sending fresh, filtered water to the mixing chamber 114. The dental appliances 132, 134 and 136 are selectively actuated for a few moments as filtered water removes any remnants of the cleaner. It should be noted that this process only takes a few minutes to accomplish and all of the functional positional steps, except for the discharging of the dental appliances 132, 134 and 136 to atmosphere, can be made semi or fully-automatic through the use of solenoid valves, air-driven valves, toggles, programmed computerized controllers, etc.

Still referring to FIG. 1, the embodiment of system 100 can also provide backflow protection. Backflow potentially allows contaminated materials to enter a potable water supply system when the pressure of the polluted source exceeds the pressure of the potable source (for example, during a water main break). Backflow protection is provided by, for example, normally-closed, positive action check valves 102 and 104 on the air and water lines that are controlled by a stainless steel spring. Even in normal air and water pressure conditions valves 104 and 102 preferably close should pressurized air or water attempt to move in the reverse direction. Should the pressure on the inlet side of the valves 104 and 102 be lower than the system-side pressure, such a loss in pressure at that point preferably enhances the “closing” force of these valves.

In addition to the presence of check valves 102 and 104, the embodiment of system 100 is generally configured to reduce microbiological contamination. Therefore, organisms passing through the system (even if in the reverse direction) would be affected by the bactericidal, bacteriostatic, and chemical-removing effects of the multi-stage filters 106 and 108 and/or other treatment components thus reducing reverse contamination that may have been drawn from a patient or other source. Furthermore, the embodiment of mixing chamber 114 provides for the presence of an air-gap 115 in the top of the chamber 114. This air-gap 115 effectively prevents backflow in the mixing chamber 114 because it separates the fluid therein from the mixing chamber's input. In addition to backflow protection being offered by check valves 102 and 104, filters 106 and 108, and air gap 115, any suction created on line 194 would also open the injection port 112 located at control manifold 110 (or mixing chamber 114, if so located) creating a siphon break.

In summary, should there be a sudden drop in water pressure and a resultant suction created at 194, essentially no fluids would be allowed to “backflow” towards the public water supply. This is because such fluids would need to flow backwards beginning at dental hand pieces 132, 134 and 136 and through dental delivery system 130. However, such fluids most likely cannot move past the air gap 115 in the mixing chamber 114. If for some reason they were able to make it backwards through the mixing chamber 114, such fluids would have to pass through bio-filter 106 where microorganisms would be killed, inactivated and/or filtered. The bio-control effect is not flow specific with filter 106. Further, if for some reason the fluids were able to make it backwards through the bio-filter 106, the check valve 102 would stop the flow. Any one of these components can work alone to remedy backflow concerns. Nevertheless, in combination, they provide a greater degree of backflow protection.

FIG. 2 shows one embodiment of a control manifold and mixing chamber assembly. Assembly 200 is preferably mounted within a cabinet if the dental system is built into casework or on a standard dental post 230, as shown. The control manifold 202 has a control network block (beneath the cover) similar in construction to retrofit adapter 400, a toggle switch 204 that indexes to various positions by controlling the air and water valves at the control block, an injection port 206 for receiving cleaner and/or medicament concentrates by use of a syringe and a system pressure gauge 208. One embodiment of an injection port 206 is described in the incorporated by reference '219 patent. The mixing chamber 220 has a housing 222 and a convenience drain 224. In one embodiment, convenience drain 224 is in the form of a manually actuatable ball valve.

It is preferred that mixing chamber 222 stay attached to the dental delivery system at all times in order to prevent potential system contamination from outside sources. Current off-line bottle systems now in wide use require removal and filling of the bottle at least daily that encourages system contamination. However, the mixing chamber 222 can also be removed if necessary and filled manually as might be necessary in the case of water system supply failure.

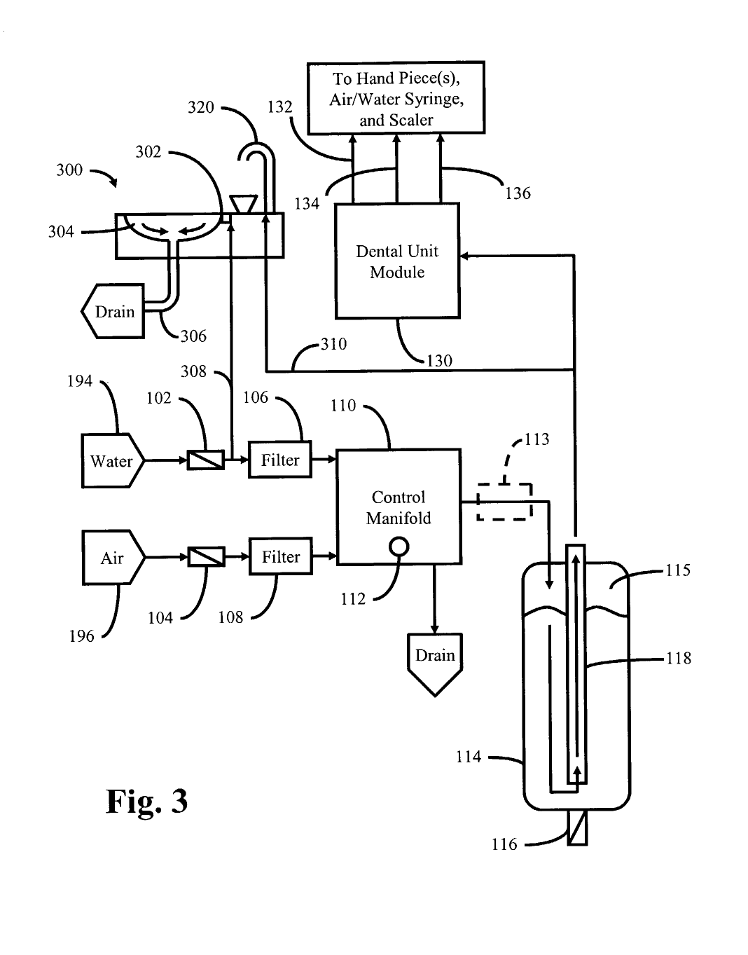

Referring now to FIG. 3 a system nearly identical to that of FIG. 1 is shown except that it also shows a cuspidor/cup filler module 300 in use. Cuspidor modules 300 are often used in dental offices and are mounted directly beside a patient chair for the convenience of the patient for rinsing and then expectorating into the cuspidor bowl 304. Also, clinical staff or a patient may draw a cup-full of water for patient consumption at faucet 320 on the module 300.

The quality of the water that rinses cuspidor bowl 304 is not of concern because it is used to rinse expectorated fluids down drain 306. Hence, the embodiment of FIG. 3 allows non-filtered water to run to the cuspidor sink inlet fitting 302 by way of a bypass line 308 that begins after check valve 102 and ends at inlet fitting 302. However, the quality of the water for the cup filler or faucet 320 is very important since a patient both rinses with and may drink the water. In this regard, the embodiment of FIG. 3 allows filtered water to run to the cup filler faucet 320 by means of a second bypass line 310 that begins after the mixing chamber 114 and ends at the cup filler faucet 320.

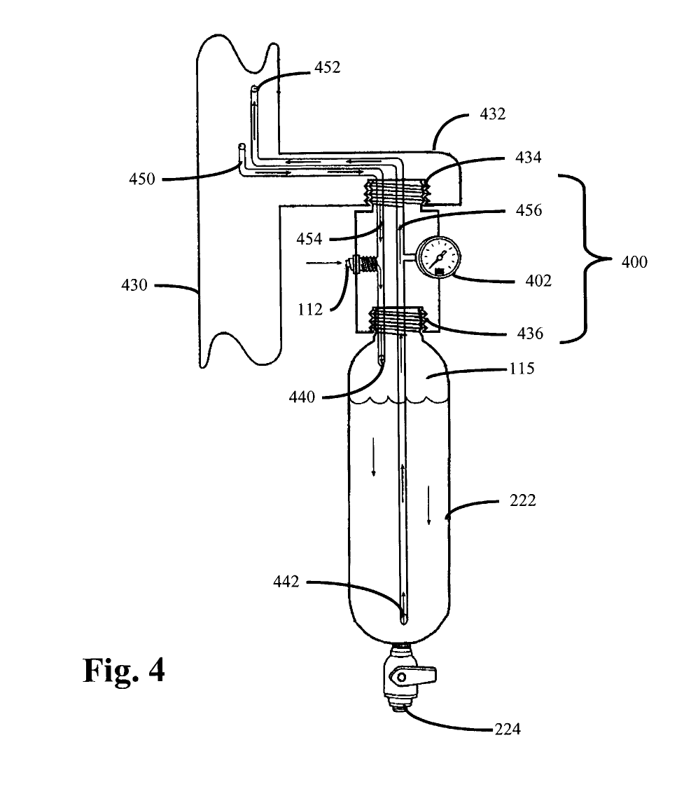

Illustrated in FIG. 4 is a perspective cut-away drawing of one embodiment of a retrofit adapter system 400. This embodiment can be used to retrofit existing water delivery systems that may or may not already be equipped with bottle delivery systems. Retrofit adapter system 400 is affixed to any conventional dental post 430 or system module housing 432. This connection is preferably accomplished by a threaded or “O” ring connection at 434. This connection attaches input water/air line 450 from the dental post or system module to a corresponding input water/air line 454 in the retrofit adapter 400. Similarly, the connection attaches output line 452 from the dental post or system module to a corresponding output line 456 in the retrofit adapter 400.

The retrofit adapter 400 further has injection port 112 and a pressure gauge 402. Injection port 112 is preferably in the line of the input water/air line 454. Pressure gauge 402 is preferably in the line of the output line 446. The retrofit adapter 400 further includes a second connection at 436 that is used to attach mixing chamber 222.

In operation, water preferably from bio-filter 106 (not shown) and control manifold switch 202 (not shown) enters the tubing network through tubing 450, flows past injection port 112 and into the mixing chamber 222 at inlet 440. As filtered water fills mixing chamber 222, it compresses any existing air in the chamber to form air gap 115. As water is needed for the endpoint dental unit module (not shown), the water pressure forces water out of the mixing chamber through outlet 442, past pressure gauge 402 and out through network tubing 452.

In order to introduce waterline cleaner concentrates and/or medicaments into the system, the same procedure as described above for FIG. 1 is followed. In brief, system pressure must first be relieved and water drained from the mixing chamber 222 and dental waterlines 450 and 452. This is accomplished by turning off the water supply feeding 450 and opening the air supply that will enter the system also through 450. The convenience drain 224 and all dental appliances (air/water syringe, high/low speed handpiece and scaler not shown) at the endpoint module are opened until all of the water is evacuated from the mixing chamber 222 and the waterlines. The air supply is turned off then convenience drain valve 224 is closed with pressure at 402 now at approximately 0 psi. A cleaner concentrate is injected at injection port 112 and falls into mixing chamber 222. The water supply feeding the system is restored providing filtered water through 450 and mixes with all of the cleaner previously injected. To deliver the cleaner or medicament without further dilution, the water supply is turned off, the air supply is turned on that causes a downwardly push on the fluid column in mixing chamber 222. This sends the fluid out through outlet 442 and on to the endpoint appliances.

In some cases a diminishing residual of certain medicaments or agents would be desirable for use on patients. To accomplish this, all of the same directions listed above apply except that the water supply is left on instead of switching to air as the delivery force. In this manner, after mixing, new water flowing into the mixing chamber 222 will be further and further diluted until a new injection of medicaments or agents is desired. It has been shown that this parabolic concentration sequence can have distinct negative effects on microorganisms.

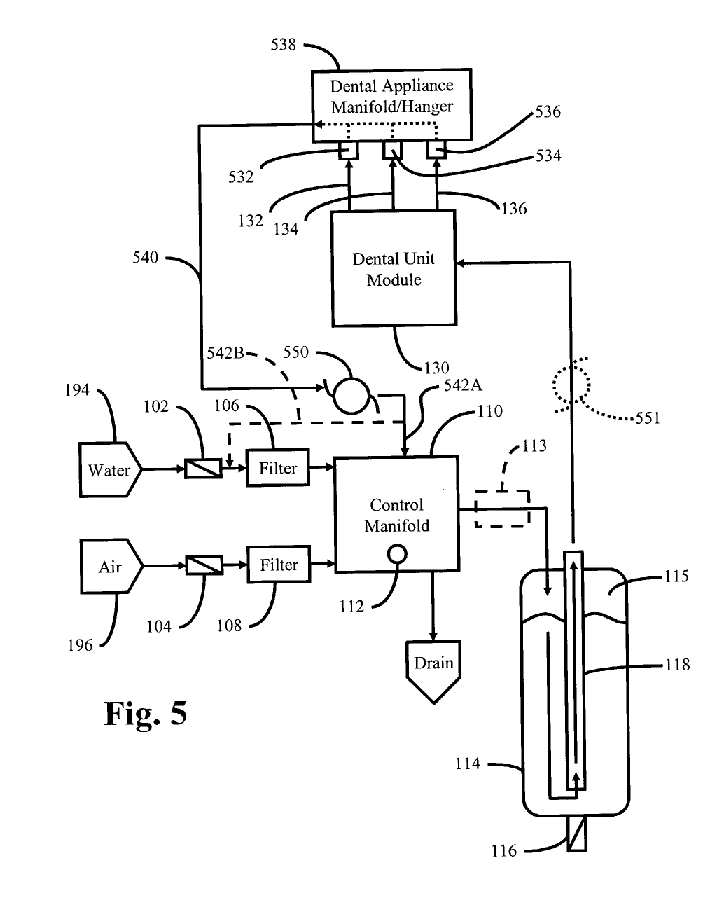

FIG. 5 is a one embodiment of system that is nearly identical to FIG. 1 except that it also shows a recirculating system in place. This embodiment is designed to eliminate the terminal dead-end legs that are common to most standard dental delivery systems. When dental appliances 132, 134 and 136 are not in use, the tubing supplying water to each device is preferably attached to a dental appliance recirculation manifold/hanger module 538 having quick couple input ports 532, 534 and 536. These input port means are preferably quick-release fluid fittings that connect two fluid carrying bodies together. In this embodiment, the quick couple input ports 532, 534 and 536 are substantially of the same construction as the input ports present on the dental appliances to which appliance tubing 132, 134 and 136 is coupled.

In this manner, tube connectors that would normally be simply hung on a clip and exposed to the contaminated atmosphere over nights and weekends are firmly connected and engaged to the ports on dental appliance manifold/hanger module 538 allowing water to recirculate through the system, as caused by a recirculator pump 550. The pump 550 is preferably powered by an electrical power source (not shown) and can also be located in the line after mixing chamber 114, as shown at 551. When the dental appliance tubing is connected properly to the corresponding quick couple input ports 532, 534, and 536, the recirculator pump 550 pulls water from the appliance tubing 132, 134 and 136 through the recirculation return line 540. If the pump is installed after the mixing chamber 114, water is pulled from the mixing chamber 114 and is sent via dental unit module 130 to the dental appliances 132, 134, and 136, then quick couple ports 532, 534, and 536, through dental appliance manifold/hanger module 538 and is sent back to mixing chamber 114 via line 540 and control manifold 110. Once at the recirculator pump 550, the water or cleaning agents can then be directed through tubing 542A, through the control manifold 110, into the mixing chamber 114, back to the appliance tubing 132, 134 and 136, and then into the manifold/hanger module 538 to create a closed loop circuit.

Alternatively, after the fluids leave the recirculator pump 550, they can be directed through tubing 542A, through the control manifold 110 but then directed to the automatic system drain 560 creating an open loop and all fluids are removed from the system. Still another recirculation alternative is to direct water from the recirculation pump 550 through tubing 542B where it reenters bio-filter 106 (or other treatment such as ultraviolet, ozone, membrane, etc.), is directed through control manifold 110 into mixing chamber 114, back to appliance tubing 132, 134 and 136, and then into the manifold/hanger module 538 to create a closed loop filtration circuit. This can be accomplished by placing the appropriate valves at the junction of tubing 542A and 542B and integrated into control manifold 110.

The embodiment shown of FIG. 5 provides numerous fluid control methods that discourage the establishment of biofilms by eliminating the dead-end legs created by normal dental delivery systems. It should be noted that tubing 542A and 542B could also both be directed to the control manifold 110 then re-directed via one or more valves specifying whether the fluids therein are directed to either the bio-filter 106 or mixing chamber 114. In addition, this embodiment can also be designed to operate without the need for manually actuation of dental appliances, which saves time for clinical staff and helps avoid potential error and contamination by humans. As such, the embodiments can employ automated controls that include a controller and electromechanical flow valves.

It should also be noted that most dental clinics and operatories have solenoid operated control valves that close the pressurized water source valve in order to prevent flooding that is often caused by weak dental line tubing and higher water pressures experienced at nighttime. The embodiment of FIG. 5 could also be made to recirculate throughout the nighttime or over weekends by use of a timer system operated by the control manifold 110 since in the recirculation mode the system has its own supply of water and/or cleaning agent stored in the mixing chamber 114.

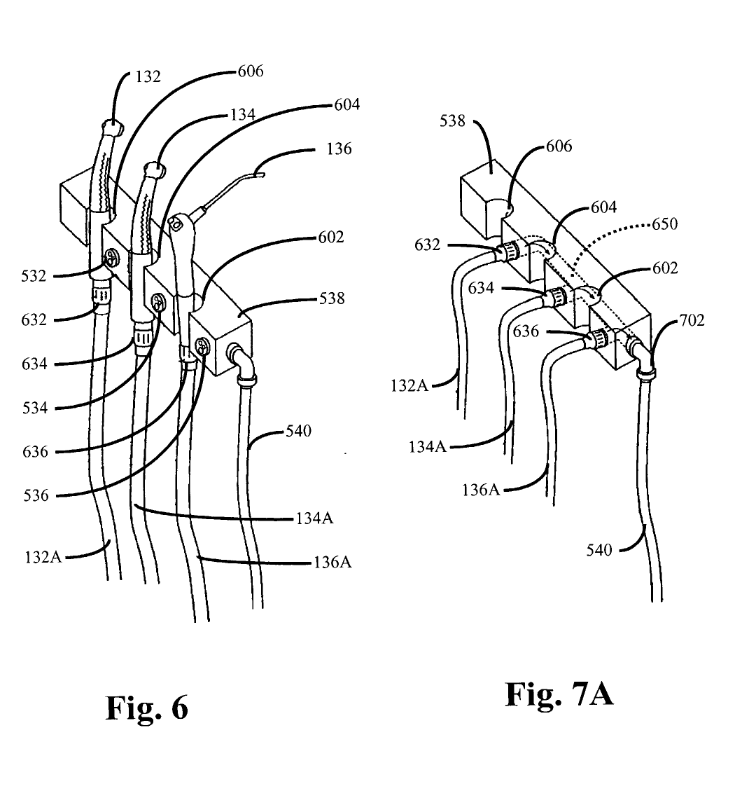

FIG. 6 and FIG. 7 illustrate two different embodiments a dental appliance recirculating manifold/hanger module 538. In standard dental delivery systems, the dental appliances 132, 134 and 136 are usually stored in recessed holders or hanger clips generally shown as 602, 604, and 606. Between patients and at the end of the day, the appliances are typically removed and sent to an autoclave where they are sterilized for the next use. As such, appliance couplings 632, 634 and 636 are generally hung in these means for holding or holder clips 602, 604, and 606 and exposed to the contaminants found in the operatory. Holder clips 602, 604, and 606 are arcuate in nature and have a radius larger than the tubing connected to the appliance couplings 632, 634 and 636 and slightly smaller than the radius of the couplings or appliance connected thereto.

Referring now more particularly to FIG. 6, during a normal patient day, filtered water flows to the dental appliances 132, 134 and 136 through tubing 132A, 134A and 136A and the quick couple ports 532, 534 and 536 are not in use. When the appliances are removed from their couplings 632, 634 and 636 at the end of the patient day, the couplings 632, 634 and 636 are attached to their respective quick couple ports 532, 534 and 536, as shown in FIG. 7. Quick couple ports 532, 534, and 536 are preferably configured to provide a twist on-off coupling between themselves and couplings 632, 634, and 636. As such, coupling 632 can be a first connector and quick couple port 532 can be a second connector.

In this regard, coupling 632 preferably has a connector portion. The connector portion can be one of four types including, for example, a 2-hole (also called a Borden Connector); 3-hole; 4-hole (also called a Midwest Connector); and 5-hole. In a 4-hole connector, the holes are (1) drive air, (2) chip air, (3) water and (4) exhaust. For a 5-hole connector, the fifth hole typically includes a fiber optic bundle. Hole locations are determined by an ISO specification. So configured, the quick couple ports are constructed with similar connector portion that releasably engage with any one or more of these connector hole configurations.

The quick couple ports 532, 534, and 536 connect the appliance couplings 632, 634, and 636 to the recirculation loop circuit. When actuated either manually or by a control system, the water or cleaning agent flows from tubing 132A, 134A and 136A through the quick couple ports 632, 634 and 636 into the bore 650 found within the recirculating manifold/hanger module 538. The fluid is driven out of passage 650 through an output port means and into the manifold circulation return line 540 where it proceeds to the recirculation pump 550 shown on FIG. 5. Passage 650 can be any channel, tubing, bore or equivalent. The output port means can be a hole or aperture or fitting.

One embodiment of a coupling 632 and quick couple port 532 is shown in FIG. 7B. Quick couple port 532 includes male threads 704 and a check valve assembly 706. Check valve assembly 706 has a channeled post 708, check ball or poppet assembly 710, and spring 712. Spring 712 biases check ball or poppet assembly 710 against a reduced channel portion of the interior of post 708. Configured as such, check valve assembly 706 is closed until a force greater than the force generated by spring 712 causes check ball or poppet assembly 710 to move away from the reduced channel portion of post 706. This opens the check valve assembly 706.

Quick couple port 532 is configured to mate with the connector of coupling 632. In this regard, port 708 mates with the fluid output portion of coupling 632 and its associated tubing. Coupling 632 has female threads 712 that mate with male threads 712 to releasably secure coupling 632 to quick couple port 532. When connected together, the fluid flowing from coupling 632 opens check valve assembly 706 and allows the fluid to flow through the interior channel of post 708 and on into bore 650 for recirculation. When there is no fluid flow or very little fluid flow, check valve assembly 706 closes. Hence, check valve assembly is self-sealing when coupling 632 is not connected or when there is no substantial flow of fluid from coupling 632.

FIG. 7C shows coupling 632 in the exemplary embodiment of a 5-hole connector portion 714. In this embodiment, hole 716 is connected to tubing 132A and mates with post 708 of quick couple port 532 when connected thereto. Otherwise, 5-hole connector portion 714 is typically connected a dental handpiece.

It should be noted that while the illustrated embodiment shows a threaded connection between quick couple port 532 and coupling 632, other types of connecting structures can also be used. For example, a mating bayonet mount can be used to couple the components together.

It should be noted that, once the appliance tubing couplings 632, 634 and 636 are manually connected to quick couple ports 532, 534 and 536, the recirculation of the water or cleaning agents may be performed in any of the modes described above. These modes can be performed by manual, semi-automatic or automatic means depending upon the particular configuration of the system.

It should still further be noted that a filtration or sterilization means can be installed with access provided to the fluid in the bore or channel 650 of the manifold/hanger manifold 538. As such, access to install a bio-filter, ultra violet light sterilizer, ozone or membrane filter can be through fitting 702. So configured, the fluid in bore or channel 650 would exit the manifold/hanger assembly 538 through fitting 702, enter the filter/sterilizer and exit there from into tubing or line 540.

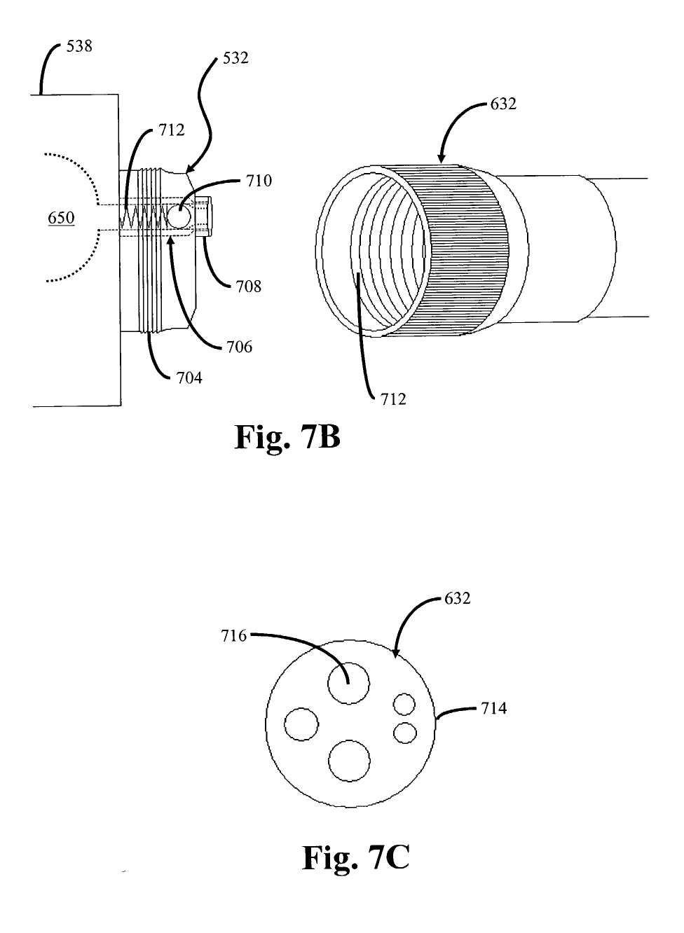

Referring now to FIG. 8, a third embodiment of the present invention is shown. The system 800 includes a manifold 802 that is in fluid communication with a pre-filter 808, bio-filter 810, and mixing chamber 820. The manifold 802 is preferably of a cylindrical cross-section geometry. However, other configurations including oval, rectangular, and triangular cross-sectional geometry can also be employed. A plurality of valves including valves 806, 812, 818, and 822 control the flow into and out of the manifold 802. Alternatively, pre-filter 808 can be a combination pre/bio-filter such as pre/bio-filter 910 and bio-filter 810 can be an ultraviolet module, ozone or other treatment device. So configured, system 800 includes two service modes and a maintenance mode of operation. In the first service mode, filtered water is supplied to the operatories. In the second service mode, filtered including a residual amount of a natural active agent or medicament is supplied to the operatories.

In the first service mode, water 804 from a city supply, well, or other pressurized source enters the manifold 802 through valve 806. A pressure gauge is provided for monitoring the pressure of the water source. Water proceeds through the manifold 802 and enters pre-filter 808. Pre-filter 808 is a granular-activated carbon/sedimentation and/or redox media filter where particulates down to 10 microns are removed from the water. After the pre-filter 808, the water proceeds to bio-filter 810. Bio-filter 810 is a ceramic microbial filter that physically traps bacteria, certain viruses, cysts, protozoans, and other microbes. The ceramic microbial filter is a porous structure having a 0.9 micron pore structure contained within a polypropylene filter housing. After bio-filter 810, the now filtered water again enters manifold 802 where it exits through valve 812 and is directed to one or more dental operatories or a storage vessel similar such as, for example, a storage tank that may be pressurized. The above-described service mode is accomplished placing valves 806 and 812 in the open position and valves 818 and 822 in the closed position.

In the second service mode, the system 800 is first depressurized by closing valves 806 and 818 and opening valve 822. Once the system 800 is depressurized, valve 822 is also closed. A concentrate of cleaner or active agent is then injected through input port 826 into the manifold 802. The system 800 is now pressurized with water by opening valve 806 causing the active agent and filtered water to mix in mixing chamber 820. Once system 800 is pressurized, valve 806 is once again closed. Valve 818 is opened to allow pressurized air 816 to enter manifold 802 to exert pressure on the mixed active agent and filtered water residing in mixing chamber 820. As the various appliances in the operatories are used, the compressed air 816 forces the active agent and filtered water mixture out of mixing chamber 820 and to dental supply 814. As already described, this service mode is used with a natural active agent such as, for example, natural botanical extracts. Once the mixing chamber has been emptied by the pressurized air 816, the above-described procedure must be repeated to replenish the active agent and filtered water mixture in the mixing chamber 820.

It may be desirable on a weekly, monthly, or other frequency basis, to add an active agent or cleaner to the system 800 for destroying biofilms and organisms that may have entered the system at one or more points further away from the filters. In this maintenance mode, the system 800 is first depressurized by closing valve 806 and opening valve 822 to drain the manifold and filters. After the system 800 has drained, valve 822 is once again closed. The active agent or cleaner is then injected with a syringe into input port 826. Valve 806 is then opened to pressurize the system 800 and to mix the active agent with the filtered water in the mixing chamber 820. After pressurization and mixing, the valve 806 is once again closed. Pressurized or compressed air 816 is introduced into the system 800 by opening valve 818. At this stage, valves 806 and 822 are closed and valves 812 and 818 are open. The pressurized air 816 is used for forcing the active agent mixture out of the mixing chamber 820 and through valve 812 to the dental operatories. In the operatories, an operator now runs the various appliances that use the supplied water until the active agent mixture begins to emerge from such appliances. The active agent may include a trace color (e.g., pink) so that the operator can detect the emergence thereof from the appliances. The active agent mixture preferably remains in the system 800 and dental operatories for a prescribed period of time that can range from minutes to hours depending on the type of active agent used.

A preferred active agent for attacking preexisting biofilms in piping, tubing and equipment is a composition containing hydroperoxide ions and a phase transfer catalyst. This agent has the ability to destroy both planktonic and sessile organisms, but more importantly attacks and dissolves the structural components of the biofilm. The agent should be both lipid and water soluble acting as both oxidizer and hydrolyzer. The phase transfer catalyst is mainly responsible for destruction of the structural aspects of the biofilm. It is preferably that water having the agent at about 7% concentration should be sent to all points throughout the plumbing system of the present invention until a residual of the agent emerges (as evidenced by a pink-colored tracing agent such as Lorvi Disclosing Agent). If a natural citrus botanical is used as a cleaner, a concentration of up to about 1% concentration should be sent to all points throughout the plumbing system of the invention until a residual of the agent emerges.

After disinfecting the system 800 and the operatories, the active agent mixture is flushed there from. This accomplished by now opening valve 822 to first flush manifold 802. Manifold 802 is flushed by the pressurized air 816 emptying mixing chamber 820 through drain 824. Further, the operatory lines are first air purged by discharging each dental appliance until the active agent is displaced by air. The operatories are now flushed by closing valve 818 and opening valve 806 to pressurize system 800 with filtered water. At this point, valves 806 and 812 are open and valves 818 and 822 are closed. The dental appliances in the operatories are now flushed until the trace color or foam of the active agent used is no longer present in the discharge.

Referring now to FIG. 9, another embodiment of the present invention is shown. The system 900 includes a combination manifold and mixing chamber 902 that is in fluid communication with a combination pre-filter and bio-filter 910. The combination manifold and mixing chamber 902 is preferably of a cylindrical cross-section geometry. However, other configurations including oval, rectangular, and triangular cross-sectional geometry can also be employed. A plurality of valves including valves 906, 918, and 928 control the flow into and out of the combination manifold and mixing chamber 902. Similar to the embodiment of FIG. 8, the system 900 also includes two service modes and a maintenance mode of operation. In the first service mode, filtered water is supplied to the operatories. In the second service mode, filtered including a residual amount of a natural active agent or medicament is supplied to the operatories.

In the first service mode of operation, water 904 from a city supply, well, or other pressurized source enters the combination manifold and mixing chamber 902 through valve 906. A pressure gauge is provided for monitoring the pressure of the water source. Water proceeds through the manifold and mixing chamber 902 and enters combination pre-filter and bio-filter 910 through tubing 908. The combination pre-filter and bio-filter 910 is shown in more detail in the cross-sectional view of FIG. 11.

Referring now to FIG. 11, the combination pre-filter and bio-filter 910 includes a cylindrical housing 1106 having input 1102 and output 1104. Within housing 1106, a pre-filter 1110 having a bed of high-purity zinc and copper blend that provides for reduction-oxidation reactions. One exemplary blend of zinc and copper is in the form of KDF 55 media. The pre-filter 1110 preferably surrounds a cylindrical bio-filter 1112. Bio-filter 1112 is a ceramic microbial filter that physically traps bacteria, certain viruses, cysts, protozoans, and other microbes. The ceramic microbial filter is a porous structure having a 0.9 micron pore structure contained within a polypropylene filter housing. A porous pad 1108, which is held in place by compression spring 1114 or springs 1114 and 1116, maintains pre-filter 1110 in a compacted state and filters particulates down to 10 microns. Compression springs 1114 and 1116 are preferably made from polypropylene or other food-grade material. So configured, water enters input 1102 and passes through pad 1108, pre-filter 1110, and bio-filter 1112 before it exits through output 1104.

Referring once again to FIG. 9, the now filtered water leaves the combination pre-filter and bio-filter 910 and enters combination manifold and mixing chamber 902 through tube 912. The mixing chamber within combination manifold and mixing chamber 902 fills with filtered water. The filtered water is now ready to exit the combination manifold and mixing chamber 902 on its way to various dental operatories through dental supply 914.

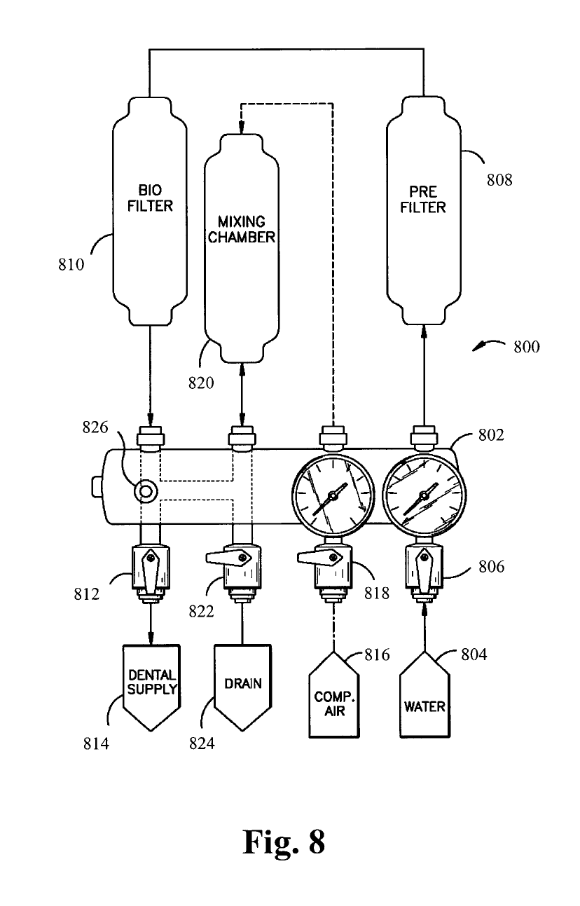

Referring now to FIG. 10, a cross-sectional view of the combination manifold and mixing chamber 902 of FIG. 9 is shown. The combination manifold and mixing chamber 902 includes a mixing chamber 1002, supply water feed 1004, compressed air feed 1006, active agent feed 1008, miscellaneous port 1010, dental supply port 1012, drain port 1022 and filter output feed 1014. All of the feeds and ports are preferably threaded for easy configuration with standard components such as valves, plugs, and quick connect and disconnect tube fittings. As shown in FIG. 9, valve 906 is connected to supply water feed 1004, valve 918 is connected to compressed air feed 1006, and valve 928 is connected to drain port 1022. In the embodiment shown, miscellaneous port 1010 is plugged. For ease of manufacture of the mixing chamber 1002, the drain port 1022 is formed in a removable end piece 1018 that is threaded with threads 1020 into and forms part of the combination manifold and mixing chamber 902. A rubber o-ring 1016 is provided to seal the threaded interface.

In the second service mode, the system 900 is first depressurized by closing valves 906 and 918 and opening valve 928. Once the system 900 is depressurized, valve 928 is also closed. A concentrate of active agent is then injected through reverse check-valve 920 into the mixing chamber 1002 (see FIG. 10). The system 900 is now pressurized with water by opening valve 906 causing the active agent and filtered water mix in mixing chamber 1002. Once system 900 is pressurized, valve 906 is once again closed. Valve 918 is opened to allow pressurized air to enter mixing chamber 1002 to exert pressure on the mixed active agent and filtered water residing. As the various appliances in the operatories are now used, the compressed air forces the active agent and filtered water mixture out of mixing chamber 1002 and to dental supply 914. As mentioned, this service mode can be used with a natural active agent such as, for example, citrus botanicals or medicaments. Once the mixing chamber has been emptied by the pressurized air, the above-described procedure must be repeated to replenish the active agent and filtered water mixture in the mixing chamber 1002.

Similar to the embodiment shown in FIG. 8, it may be desirable on a weekly, monthly, or other frequency basis, to add an active agent or cleaner to the system 900 for destroying biofilms and organisms that may have entered the system at one or more points further away from the filters. Referring now to FIG. 9, the maintenance mode is initiated by depressurizing system 900 by closing valve 906 and opening valve 928 to drain the manifold, filters, and mixing chamber. After system 900 has drained to drain 930, valve 928 is once again closed. Compressed air valve 918 is then opened and all dental appliances in the operatory are discharged until all fluid has been displaced and air emerges from each line. Valve 918 is then closed and all pressure is relieved from the system by opening any of the dental appliances or drain valve 928. The active agent or cleaner is then injected with a syringe into reverse check valve 920. Valve 906 is then opened to pressurize the system 900 and to mix the active agent with the filtered water in the mixing chamber 1002 (shown in FIG. 10). After pressurization and mixing, the valve 906 is once again closed. Pressurized or compressed air is introduced into the system 900 by opening valve 918. At this stage, valves 906 and 928 are closed and only valve 918 is open. The pressurized air is used for forcing the active agent mixture out of the mixing chamber 1002 and to the dental operatories through dental supply 914. In the operatories, an operator now runs the various appliances that use the supplied water until the active agent mixture begins to emerge from such appliances. As described earlier, the active agent preferably includes a trace color (e.g., pink) or foamy action so that the operator can detect the emergence thereof from the appliances. The active agent mixture preferably remains in the system 900 and dental operatories for a prescribed period of time that can range from minutes to hours depending on the type of active agent used.

After disinfecting the system 900 and the operatories, the active agent mixture is flushed there from. The is accomplished by now opening valve 928 to first flush the mixing chamber 1002. The mixing chamber 1002 is flushed by the pressurized air forcing any remaining active agent and water mixture through valve 928. Each operatory appliance is then discharged until all the active agent is displaced by air. The operatories are now flushed by closing valve 918 and opening valve 906 to pressurize system 900 with filtered water. At this point, valve 906 is the only open valve. The dental appliances in the operatories are now flushed through dental supply 914 until the trace color of the active agent is no longer present in the discharge.

Still referring to FIG. 9, the system 900 includes removable mounting flanges 924 and 922. Mounting flanges 924 and 922 allow for system 900 to mounted in the proper substantially upright position. The main consideration during mounting is that the drain port of mixing chamber 1002 should configured to be at the lowest portion of the mounting to facilitate easy draining. The mounting flanges 924 and 922 can be of a plurality of well-known arrangements including arrangement for wall-mounting and mounting to a tube.

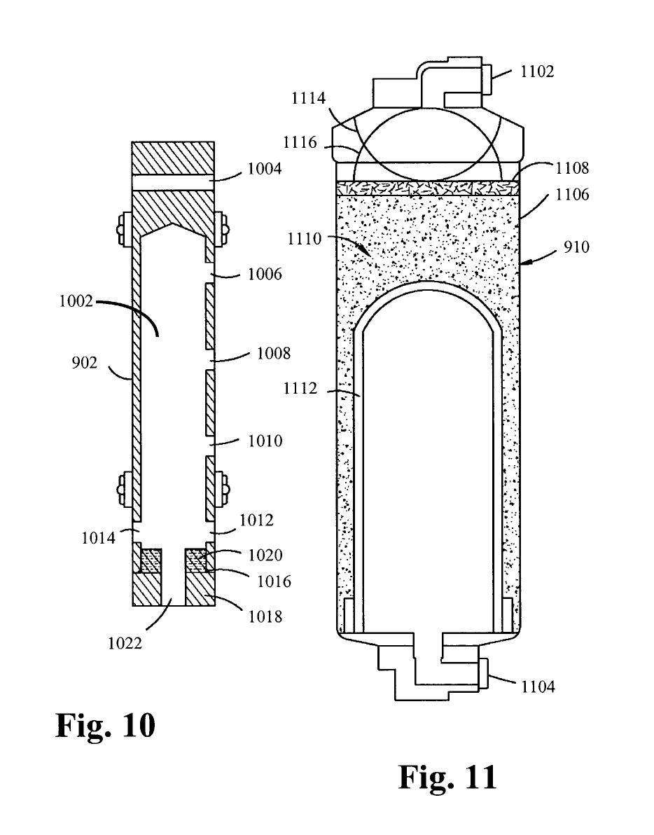

Illustrated in FIG. 12 is another embodiment of the present invention that is particularly suited for a single operatory or installations where space is an important consideration. The system 1200 includes the same combination pre-filter and bio-filter 910 as shown in system 900 of FIG. 9 and in the cross-sectional illustration of FIG. 11. The system 1200 includes a manifold 1202 that is in fluid communication with the combination pre-filter and bio-filter 910 via tubes 1212 and 1214. The manifold 1202 is preferably of a cylindrical cross-section geometry. However, other configurations including oval, rectangular, and triangular cross-sectional geometry can also be employed. A plurality of valves including valves 1204 and 1206 control the flow water and compressed air 1205 into and out of the system 1200. Manifold 1202 further includes an active agent input port 1210 and supply port 1208. As described in the earlier embodiments, active agent input port 1210 is preferably in the form of a reverse check valve. Mounting flanges 1216 and 1218 are also provided for mounting system 1200 to a wall, cabinet, chair or other mounting or installation surface. System 1200 includes a service mode and a maintenance mode of operation.

In the service mode, filtered water is supplied to the operatories. More specifically, water 1203 from a city supply, well, or other pressurized source enters the manifold 1202 through valve 1204. As in earlier embodiments, a pressure gauge is provided for monitoring the pressure of the water source. Water proceeds through the manifold 1202 and enters combination pre-filter and bio-filter 910 through tubing 1212 where it is filtered. The now filtered water leaves the combination pre-filter and bio-filter 910 and re-enters manifold 1202 through tube 1214. The filtered water is now ready to exit the manifold 1202 via supply port 1208 on its way to the appliances of the connected dental operatory.

Referring now to FIG. 13, a cross-sectional view of the manifold 1202 of FIG. 12 is shown. The manifold 1202 includes a first channel 1302 and a second channel 1304. First channel 1302 has a supply water feed 1306, a pressure gauge interface port 1308, and an exit 1310 to filter 910. Second channel 1304 has a compressed air feed 1312, active agent feed 1314, dental supply port 1316, and input 1318 from filter 910. All of the feeds, ports, inputs, and exits are preferably threaded for easy configuration with standard components such as valves, plugs, and quick connect and disconnect tube fittings.

With regard to the maintenance mode, it may be desirable on a weekly, monthly, or other frequency basis, to add an active agent or cleaner to the system 1200 for destroying biofilms and organisms that may have entered the system at one or more points further away from the filters. Referring now to FIG. 12 once again, the maintenance mode is initiated by closing valve 1204, opening valve 1206, and discharging all dental appliances connected to the dental supply port 1208. Valve 1206 is then closed and all pressure is removed from the system by discharging one of the dental appliances. After system 1200 has been drained and depressurized, an active agent or cleaner is then injected with a syringe into input port 1210. Valve 1204 is then opened to once again pressurize the system 1200. At this point, a single appliance in the operatory is run until the trace color of the active agent appears in the appliance's discharge. This procedure of depressurizing, introducing a quantity of active agent, and re-pressurizing is repeated for each appliance in the operatory because system 1200 does not include a mixing or reservoir chamber that can hold enough active agent to fill all of the delivery lines to all of the dental appliances.

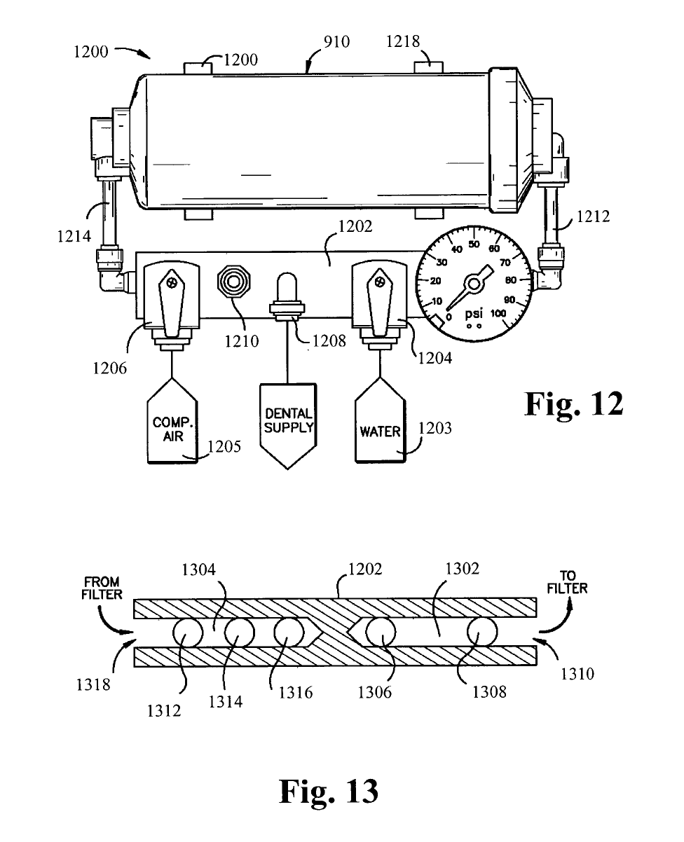

However, an optional mixing chamber/reservoir 1400 is shown in cross-section in FIG. 14 that can be easily attached to the supply port 1208 of FIG. 12 to provide the required capacity. As shown, mixing chamber/reservoir 1400 is preferably has a generally cylindrical housing 1402 that includes an input feed 1404, supply output 1406, and a drain connected to drain valve 1412. Supply output 1406 is connected to a dip tube 1408 that preferably runs through the center and almost entire depth of mixing chamber/reservoir 1400.

In operation, filtered water or active agent mixture (i.e., active agent and filtered water) enters mixing chamber/reservoir 1400 through input feed 1404 and is contained within the interior space 1410 thereof. To discharge the contents of mixing chamber/reservoir 1400, air is forced into input feed 1404 thereby pressurizing interior space 1410 and mixing chamber/reservoir 1400. Running any appliance in the operatory connected to supply output 1406 will allow the pressurized air within interior space 1410 to force any resident fluids out of interior space 1410 via dip tube entrance 1413, through dip tube 1408 and supply output 1406 to the appliance. The mixing chamber/reservoir 1400 can also be drained or depressurized by opening valve 1412. Hence, coupling mixing chamber/reservoir 1400 with system 1200 of FIG. 12 provides the same capacity and overall functionality is described for the earlier embodiments.

The active agent input ports described herein preferably comprise a reverse check valve configuration. One embodiment of a reverse check valve configuration is shown in FIG. 15. Referring now to FIG. 15, the reverse check valve configuration preferably includes a ball 1500 and spring 1502. Spring 1502 urges ball 1500 against an input aperture until the spring force is exceeded by an oppositely directed force causing ball 1500 to move away from the input aperture and allowing fluid to pass through the check valve. Active agent injection is preferably accomplished manually using a hypodermic syringe or similar device. The syringe is inserted into the reverse check valve and the active agent is injected into the mixing reservoir or chamber. Reverse check valves are particularly suitable for use because they provide for insertion of the syringe into the injection port and self-sealing of the port after injection. This procedure may be automated through conventional metering devices and automatic injection systems.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, tubing or hose size may be changed, additional valves may be added in the fluid flow paths, additional pressurized storage tanks and mixing reservoirs may be added, pressure booster pumps and flow meters can be installed within the system, an ultraviolet light disinfection unit can be placed in the fluid flow path, and optional filtration modules for the reduction of dissolved solids in the fluid can also be added to the system. Therefore, the invention, in its broader aspects, is not limited to the specific details, the representative apparatus, and illustrative examples shown and described. Accordingly, departures may be made from such details without departing from the spirit or scope of the applicant's general inventive concept.

I claim:

1. An apparatus for use in a dental system comprising:
at least one holder for holding a dental appliance when the dental appliance is not in use;
at least one input port; said input port comprising a connector for releasably connecting the input port to a mating connector that provides a source of fluid to the dental appliance; and
at least one output port in fluid communication with the input port.

2. The apparatus of claim 1 further comprising a housing having a plurality of holders for holding dental appliances when the dental appliances are not in use and a plurality of input ports, each input port comprising a connector for releasably connecting the input port to a mating connector that provides a source of fluid to the respective dental appliance.

3. The apparatus of claim 1 wherein the at least one holder and at least one input port are adjacent each other.

4. The apparatus of claim 2 where the plurality of holders and input ports are proximate to each other in an interdigitated configuration.

5. The apparatus of claim 1 wherein the at least one input port further comprises a self-sealing portion configured to allow fluid into the port and to self-seal when there is substantially no fluid flowing into the port.

6. The apparatus of claim 5 wherein the self-sealing portion comprises a check valve.

7. The apparatus of claim 5 wherein the self-sealing portion comprises a spring-biased check ball.

8. A fluid delivery system for a dental operatory comprising:
a source of fluid;
a recirculation manifold having:
at least one holder for holding a dental appliance when the dental appliance is not in use;
at least one input port; said input port comprising a connector for releasably connecting the input port to a mating connector that provides a source of fluid to the dental appliance; and
at least one output port in fluid communication with the input port; and
a pump in fluid communication with the recirculation manifold and the fluid source.

9. The system of claim 8 wherein the fluid source comprises a filter and a control manifold.

10. The system of claim 9 wherein the control manifold comprises a self-sealing active agent input port configured to at least partially receive therein an active agent injector and to self-seal when the active agent injector is not received therein.

11. The system of claim 9 wherein the filter comprises
a pre-filter for providing oxidation reduction reactions with the fluid to be filtered;
a bio-filter substantially surrounded by the pre-filter and for filtering microbials from the fluid; and
a resilient spring device and a porous material, the resilient spring device and porous material maintaining the pre-filter in a substantially compacted state.

12. The system of claim 9 further comprising a filter having an ultraviolet light source.

13. The apparatus of claim 8 wherein the at least one input port further comprises a self-sealing portion configured to allow fluid into the port and to self-seal when there is substantially no fluid flowing into the port.

14. The apparatus of claim 13 wherein the self-sealing portion comprises a check valve.

15. The apparatus of claim 13 wherein the self-sealing portion comprises a spring-biased check ball.

16. An apparatus for use in a dental system comprising:
at least one holder for holding a dental appliance when the dental appliance is not in use;
at least one input port, said input port comprising:
a connector for releasably connecting the input port to a mating connector that provides a source of fluid to the dental appliance; and
an fluid input portion for the input of at least one fluid, said fluid input portion comprising a self-sealing assembly configured to allow the at least one fluid into the input port and to self-seal when there is substantially no fluid flowing into the input port.

17. The apparatus of claim 16 further comprising at least one output port in fluid communication with the input port.

18. The apparatus of claim 16 wherein the self-sealing assembly comprises a check valve.

19. The apparatus of claim 16 wherein the self-sealing assembly comprises a spring-biased check ball.

20. The apparatus of claim 16 wherein the connector comprises at least one thread.
